(19) United States
(12) Patent Application Publication
(10) Pub. No.: US 2003/0157468 A1
(43) Pub. Date: Aug. 21, 2003

(54) Method and apparatus for rapid language acquisition

(76) Inventor: Yoshikazu Kasahara, Tokyo (JP)

Correspondence Address: BACHMAN & LAPOINTE, P.C., 900 CHAPEL STREET, SUITE 1201, NEW HAVEN, CT, 06510, US

(21) Appl. No.: 10/366,104

(22) Filed: Feb. 13, 2003

(30) Foreign Application Priority Data
Feb. 15, 2002 (JP) P2002-38629

(51) Int. Cl. G09B 19/06; G09B 19/08

(52) U.S. Cl. 434/157

(57) ABSTRACT

This invention demonstrates a method and apparatus for learning and mastering a foreign language conversation in a short period of time, by hearing it spoken at variable rates. The methods of side-by-side translation of phrases, and accelerated and decelerated listening, are employed to this end. Appropriate apparatus are described which facilitate these methods. Using this language learning system effectively enhances the listener's power of concentration and information processing capability, resulting in improved language abilities.

### TECHNICAL FIELD

This invention relates to methods and apparatus for learning and mastering a foreign language conversation in a short period of time by hearing it spoken at variable rates.

### BACKGROUND OF THE INVENTION

The field of language acquisition continues to burgeon, especially as the global market place is ever prevalent. The challenges which arise when attempting to learn a language make rapid language acquisition difficult. Mastery of a language is particularly difficult when the mother language and foreign language have structural differences.

Conventional methods for teaching English in Japan generally involve sentence by sentence translation. A typical training method with auditory information is to listen to sentences spoken at a normal or slower than normal rate. The object is for the learner to become familiar with, and to learn to understand, the spoken language.

A major difficulty for Japanese who wish to learn English revolves around the inherent difference in the structure of the two languages. The most important information when attempting to understand a sentence includes the concepts of subject, verb, and interrogative. These are decisive factors for determining whether a sentence is intended to be affirmative, negative, interrogative or conclusive. In English, this information tends to exist at the beginning of the sentence. To understand the meaning, it is necessary to correctly remember the first portion of the structure.

In contrast, Japanese sentences tend to include this information at the end of the sentence, and thus Japanese people naturally pay more attention to this portion of the structure. This presents a challenge when attempting to learn English: It is difficult to ascertain the meaning of a sentence until the end, but often (due to this natural tendency to focus on the end of the sentence) the listener will have forgotten the beginning of the sentence. For this reason, when Japanese people listen to English, they have difficulty remembering the meaning of the sentence. If the beginning of the sentence contains the key word requisite for comprehension of the content, a Japanese person may not be able to determine whether the sentence is intended to be affirmative, negative, interrogative or conclusive. The slow speed which is involved in reading English as a novice, and which is conventionally used to convey auditory information in learning situations, serves only to compound this problem; it makes it virtually impossible for a Japanese person to remember the beginning of the sentence.

It is a challenge for a learner to listen to current English, such as the news spoken at a normal rate, and be able to understand it. This is due in part to the fact that native English speakers tend to overlap the pronunciation of words, resulting in sound contractions. These sound contractions make it difficult for a learner to correctly determine the specific words and thus the meaning of the sentence. Even more difficult would be to listen to English at an accelerated rate as the frequency of sound contractions increases.

Adjusting the speed of speech for learning purposes presents other problems. Prior storage reproduction apparatus for recording and reproducing foreign languages are defective. High speed reproductions of foreign languages, which are enunciated and recorded at a normal rate using these apparatus, produce sounds in an elevated pitch. This elevated pitch makes it difficult for the listener to hear the reproduced sound. During the reproduction, the tape may also make distracting rustling noises. This problem becomes worse with further increases of the reproduction speed.

Comprehension is not the only hurdle: correct pronunciation and rhythm are also difficult to acquire. It is difficult for Japanese listeners to hear consonants which are not followed by vowels (as is the Japanese linguistic custom). Because of this, Japanese speakers tend to alter the pronunciation of English words in a manner which is not easily comprehended by native speakers. For example, a Japanese speaker will pronounce “Donald Duck” as “donarudo dakku”, converting this three syllable name into one with six syllables. In addition, Japanese pronunciation does not involve any accented syllables. In the former example, the Japanese pronunciation of “donarudo dakku” will place equal emphasis on all six syllables, travelling from one consonant to the next. In English, the first syllable of both “Donald” and “Duck” are emphasized. These accented syllables establish the rhythm of the language. A typical method, when attempting to teach the pronunciation of accented syllables, is to instruct the learner to speak the accented syllable more loudly than the other syllables; however, this tends to place the emphasis on the consonant, rather than the stressed vowel.

There are some newer approaches which deviate from conventional methods. Japanese Patent Disclosure No. 2001-331092 discloses a language learning system that enables foreign language and equivalent mother language data to be recorded in a specialized storage medium. Alternately, it phonetically reproduces this data. Repetition of this phonetic data leads to language acquisition within a relatively short period of time. The use of both the foreign language and the mother language aids in the acquisition process. Significantly, the storage medium allows the mother language to be eliminated so that only the foreign language is heard.

The tape which contains the storage medium is switch operated. The storage medium includes memory segments, each of which stores the data of a foreign language phrase and the equivalent mother language translation of that phrase. The data of each of these phrases can be independently selected and reproduced in a silent, low or loud voice mode by using the appropriate switch. Using this process, the mother language on the recording can be eliminated so that only the foreign language is reproduced. The elimination of the mother language at appropriate times is an extremely effective tool that greatly accelerates the learning process.

The above system helps increase the rate of language acquisition which in turn helps maintain the learner's interest in the process. Musical rhythm patterns and subliminal images may also be used to this end. Japanese Patent Disclosure No. 2001-42758 demonstrates a method wherein phonetic patterns of musical rhythm which are easily accepted by the learner's right brain, are chosen from foreign language materials. Background music which corresponds to these patterns is selected and repeated throughout. In this way, the music is used to represent the sounds of rhythm patterns which naturally occur in speech. Furthermore, subliminal images which express the content of the material being learned are integrated. This method thus invokes several learning faculties simultaneously. Learner's repeatedly hear and can practice pronouncing vocalized phonetic information stored in the rhythm patterns, as well as exact speech. The right brain is kept predominate so that it automatically learns the target language in association with the subliminal images.

### SUMMARY OF THE INVENTION

The present invention has the following objectives: First, provide a method and apparatus for use in learning and mastering a foreign language conversation in a short period of time, by hearing it spoken at normal and faster than normal rates. Second, produce a method and apparatus which increases the listener's power of concentration and ability to process information through accelerated and decelerated learning techniques. Third, develop an apparatus which allows for reproductions of the language in varying speeds, without the pitch, tone and noise problems which arise with prior apparatus. Fourth, offer a method and apparatus which quicken the acquisition process of the foreign language conversation. This is accomplished by listening to phrases of a foreign language sentence, with the corresponding phrases of the equivalent mother language inserted before, between, or after the foreign language phrase. Finally, improve pronunciation and rhythm by elongating stressed vowels.

To accomplish these objectives, this invention demonstrates a unique language learning system comprised of a five stage process involving repetition, acceleration and deceleration, and phrase by phrase translation.

Stage 1: Listen to a foreign language sentence spoken at a normal rate.

Stage 2: Listen to the same sentence with phrases of the mother language inserted at appropriate junctions.

Stage 3: Listen to the phrase by phrase presentation of the sentence (Stage 2) at an accelerated rate with normal pitch and tone.

Stage 4: Listen to the original foreign language phrase (Stage 1) at an accelerated rate with normal pitch and tone.

Stage 5: Listen to the original foreign language phrase (Stage 1) at the original speed.

The apparatus for learning a foreign language according to the present invention comprises a storage means, a reproduction means communicated with the storage means, and a speaker means communicated with the reproduction means. The storage medium entails five memories for storing the audio information corresponding to Stages 1-5. When the memory includes audio information which is to be reproduced at a faster than normal rate, the memory either stores the audio information with the pitch adjusted in advance, or forwards the information to the reproduction means through a pitch regulator provided in the storage means. The reproduction means thus produces accelerated speech, with normal pitch and tone, which is more easily retained, and restricts the production of excess noise. Stressed vowels are elongated in some memories to help the learner acquire a correct sense of rhythm.

### BRIEF DESCRIPTION OF THE DRAWINGS

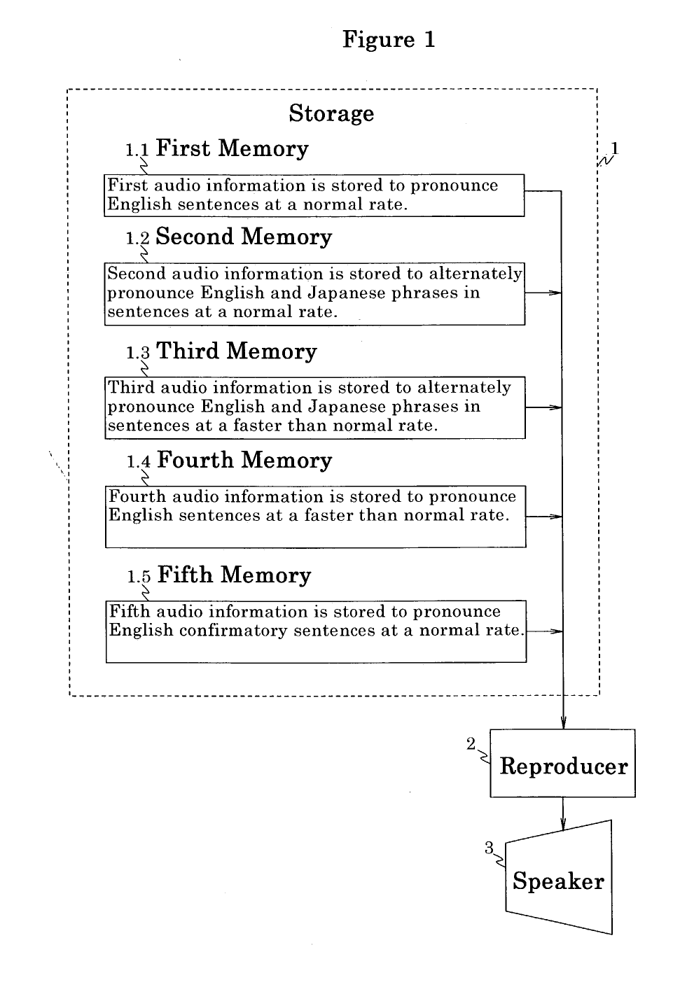

Embodiments of the present invention will be described hereafter in connection with FIG. 1. FIG. 1 is a block diagram of an apparatus for learning a foreign language conversation according to the present invention. The storage means, reproduction means, and speaker means are labeled 1, 2, and 3 respectively. Stages 1-5 above correspond to 1.1-1.5 of the figure.

### BEST MODE FOR CARRYING OUT THE INVENTION

Construction of the Invention's Apparatus

As shown in FIG. 1, the apparatus for learning a foreign language conversation according to the present invention contains a storage medium 1 with five memories 1.1 to 1.5, a reproducer means 2 communicated with this storage medium, and a speaker means 3 communicated with the reproducer. The storage medium 1 may be any suitable recording medium which allows information to be magnetically or optically written, rewritten and read. Examples of appropriate storage mediums are magnetic tapes, compact discs, mini discs and digital video discs.

Each of the five memories 1.1 to 1.5 of the storage medium is used to store a different type of audio information. There are two main considerations: the type of sentence being stored and the rate at which the sentence is to be reproduced. Every memory stores either a foreign language sentence, or a combined foreign language sentence. The combined foreign language sentence is comprised of a foreign language sentence, with equivalent mother language phrases inserted before, between, or after the corresponding foreign language phrase. The corresponding phrases have the same meaning and are separated from one another by pauses in enunciation. Either of these types of sentences may be reproduced at a normal or faster than normal rate. The usual English conversation pace tends to range from 100 to 150 words per minute; using the median serves to define the English conversation pace as 125 words per minute. Thus the normal rate is defined by speech which proceeds at 80-120% of the usual English conversation pace. A faster than normal rate is defined to be speech which proceeds at 120-220% of the usual English conversation pace.

The first, second and fifth memories 1.1 and 1.5 involve audio information which is to be reproduced at a normal rate. The third and fourth memories 1.3 and 1.4 store audio information which is to be reproduced at a faster than normal rate. The third and fourth memories 1.3 and 1.4 may store the audio information with the pitch adjusted in advance, and directly forward this information to the reproducer means 2, or forward the information to the reproducer 2 through a pitch regulator. In the latter case, a digital pitch controller (DPC) provided in the storage medium 1 is preferable. For example, a cassette recorder with a DPC is shown in Japanese Patent Disclosure No. 620448, and is available from Sony Corporation. Adjusting the pitch using one of these methods allows for accelerated reproductions with normal pitch and tone. This also reduces the number of noise disruptions which accompany high speed reproductions.

The first memory 1.1 stores the audio information of a foreign language sentence which is to be reproduced at a normal rate. The second memory 1.2 stores a combined foreign language sentence which is to be reproduced at a normal rate. The third memory 1.3 stores the combined sentence, with adjusted pitch, which is to be reproduced at a faster than normal rate. The fourth memory 1.4 stores the audio information of the original foreign language sentence, with adjusted pitch, which is to be reproduced at a faster than normal rate. The fifth memory 1.5 stores the original foreign language sentence which is to be reproduced at a normal rate. This memory is used for confirmatory purposes. In one or more of these memories, stressed vowels are pronounced 10-30% longer than is usual for the foreign language. All of these memories are reproduced through the reproducer means 2 and the speaker means 3.

### Pronunciation of English Sentences and Side-By-Side Translation of Phrases

In the embodiment of the present invention, the second and third memories 1.2 and 1.3 respectively contain information of English sentences, denoted as Information A, and phrase information of English-Japanese side-by-side translation, denoted as Phrase Information B.

Information A:

Information A stores English sentences for use in listening to complete English sentences. For example:

Mike told me that he went shopping in New York yesterday, and that he saw Lana at the department store for the first time in the long time.

Phrase Information B:

Phrase Information B stores both English and Japanese sentences in accordance with the method of side by side translation of phrases. In this case, the Japanese phrase follows the appropriate English phrase as in the following example:

Mike told/Maiku-wa-itta (Japanese translation) (JT))/me/watakusini (JT)/that/sore-o (tsuginokoto-o)(JT)/he went shopping/kare-wakaimono-ni-yukimashita(JT)/in New York/nyuyoku-ni(JT)/yesterday/kinou(JT)/, and/sosite(JT)/that he saw/kare-wa-aimasita(JT)/Lana/rana-ni(JT)/at the department store/depaato-de(JT)/for the first time/hajime-te(JT)/in a long time/nagaiaida-ni(sunawati-hisasiburi-ni) (JT).

In this specification, the “phrase” refers to a minimum unit interrupted by natural pronunciation. English pronunciation areas of Information A and Phrase Information B store voices which all enunciated by native English speakers. These voices include stressed vowels which are pronounced for 10-30% longer than is usual in English pronunciation. Through practice, this enables learners to acquire a correct sense of rhythm and helps to improve pronunciation. Elongating stressed vowels inhibits the Japanese speakers' tendency to follow a consonant by a vowel where one does not exist, and produces a relatively shorter pronunciation of consonants and unstressed vowels. For example, recall the Japanese pronunciation “donarudo” of the name “Donald”. In this case, Japanese speakers will preferably pronounce “donarudo” in a closer approximation to the English version, by elongating the first syllable “do”, and pronouncing the last three in a small voice without any vowel. Although the stressed vowel is pronounced for too long, this pronunciation is still intelligible to native speakers. Thus, the elongated pronunciation of stressed vowels encourages proper enunciation, and a closer approximation of a native accent.

Using this combination of side-by-side translation with elongated stressed vowels, learners are able to make efficient increases in listening and speaking abilities. Although the side-by-side translation of phrases arranges the Japanese phrases in an order which is irregular to the Japanese speaker, it still enables the listener to accurately determine the meaning. As well, cutting the English sentences after each phrase helps reduce the number of sound contractions which would normally occur. This makes it easier to distinguish the individual words, a beneficial side effect of the process. After Japanese speakers become accustomed to elongated pronunciation of stressed vowels, they can then learn pronunciation of consonants such as “th”, “r”, “1” and “v”.

### Five Fundamental Rules when Preparing Phrase Information B

Phrase information B should be prepared in accordance with the following five fundamental rules:

First Rule:

An English sentence is divided by inserting a pause after a subject, a predicate verb, an object, a complement, a modifier word or phrase, or a connective word or phrase. The sentence is then translated into Japanese by applying a particle or auxiliary word to each of these units, with certain exceptions. No particle or auxiliary word is applied to predicate verbs, certain adverbs, or to connective words or phrases.

Second Rule:

In most cases, a subject and a verb are translated together in a segment so as not to separate those which are consecutive. The Japanese translation is placed after the segment. However, if a modifier word or phrase, or a parenthetical expression, is interposed between a subject and a verb, the subject and verb are translated independently.

Third Rule:

When the verb “be” is used as a predicate verb in the second sentence pattern (that is, a sentence with subject, verb and complement), it is translated with the complement as a segment. The Japanese translation is then added after this segment.

Fourth Rule:

The corresponding Japanese translation is inserted into each pause that follows a subject, a predicate verb, an object, a complement, a modifier word or phrase, or a connective word or phrase.

Fifth Rule:

For a relative pronoun and a relative adverb, the following Japanese translations:

Who: [sosite, sonohito (tachi) wa],

Whose: [sosite, sonohito (tachi) no] or [sosite, sore (ra) no],

Whom: [sosite, sonohito (tachi) o] or [sosite, sonohito (tachi) ni],

That: [sosite, sonohito (tachi) wa] or [sosite, sore (ra) wa],

Which: [sosite, sore (ra) wa],

In which: [sosite, sore (ra) no nakade],

Of which: [sosite, sore (ra) no],

Where: [sosite, sokode],

When: [sosite, sonotoki].

are used, and added after the appropriate phrase of the English sentence.

These rules are necessary due to inherent differences in the two languages. There are significant differences in both the structure of the languages, and the parts of speech involved in each. In the English language, the word order determines the meaning and function of the words and phrases involved, and hence the meaning of the sentence as a whole. Consider the following sentence:

“Mike told me that he went shopping in New York yesterday and that he saw Lana at the department store for the first time in a long time.”

Rewriting this sentence in accordance with Japanese language order yields:

“Yesterday, Mike he in New York shopping went and he at the department store for the first time in a long time Lana saw that me told.” As is evident from this example, altering the word order destroys the integrity of the sentence, rendering it unintelligible. Thus the structure and construction of the sentence are extremely important in English.

In the Japanese language, the particles or auxiliary part of the individual clauses are the most important. Every sentence is sectioned into clauses by particles or predicate verbs; the meaning of the sentence is determined by the meaning and function of these particles or auxiliary parts. Rearranging the individual clauses in a Japanese sentence, so that the particles or the auxiliary part is intact, does not destroy the meaning of the sentence.

One of the reasons that the structures of the two languages differ, is that they make use of different parts of speech. There is no equivalent to the Japanese auxiliary particle in the English language. In some cases, a preposition may serve as an auxiliary particle; however, it is not possible to use them with all phrases, only predicate verbs. The absence of this particle is one of the reasons that word order and structure are so important in the English language.

By translating sentences phrase by phrase, so that the particles are placed appropriately according to the five fundamental rules, the learner can readily comprehend the meaning. This is a significant improvement over the method of sentence by sentence translation, which is difficult for learners to follow.

### Examples of Side-By-Side Translation Based on the Five Fundamental Rules

First Sentence Pattern: Subject and Verb

1. The manager lives/sono buchou wa, sundeimasu/in a very wealthy area/totemo-yuufuku-natiiki-ni.

2. My wife/watakusi-no-tsuma-wa,/usually/fudan/wakes up/okimasu/at six/rokuji-ni.

3. I/watakusi-wa/often/yoku/go/yukimasu/jogging/joggingu-ni/early/hayaku-ni/in the morning/gosenchu-ni.

Second Sentence Pattern: Subject, Verb and Complement

1. She looks/kanojo-wa, miemasu/very upset/totemo-douyousiteiruyouni.

2. His wife/kare-no-tsuma-wa,/is tall and slim/sega-takakute, surimudesu.

3. I'm satisfied/watakusi-wa, manzoku-shiteimasu/with the results/sono-kekka-ni.

4. The line/sono-sen-wa,/was busy/kondeimasita (hanasichu-desita).

Third Sentence Pattern: Subject, Verb and Object

1. He's dominating/kare-wa, shikitteimasu/the conversation/sonokaiwa-o.

2. He stopped/kare-wa, yameta/laughing/warauno-o.

3. She likes/kanojo-wa, sukidesu/it/sore-o/very much/totemoyoku.

4. One/hitori-wa/of our colleagues/watakusi-tachi-no-doryo-no/suggested/teian-sita/the new plan/sono-atarashii-kikaku-o/at the meeting/kaigi-de.

5. The virus produces/sono-kin-wa, tsukuridashimasu/the acid/sanwo.

Fourth Sentence Pattern: Subject, Verb, Object and Object

1. I'll bring/watakushi-ga, motte-kimashou/you/anata-ni/something/nami-ka-o/to drink/nomu-tame-no

2. Show/misete-kudasai/me/watakusi-ni/your driver's license/anata-no-unten-menkyosho-o/please/onegai-itashimasu.

3. I'll let/watakushi-ga, sasemashou/you/anata-ni/know/shirukotowo/how to get/yukikata-o/there/sokoe-no.

4. She made/kanojo-wa, tsukutta/me/watakushi-ni/some tea/ikuraka-no-ocha-o.

5. Could you give/kuremasenka/me/watakushi-ni/your phone number/anata-no-denwabangou-o/please?/onegaishimasu.

Fifth Sentence Pattern: Subject, Verb, Object and Complement

1. The news made/sono-nyusu-wa, shita/me/watakushi-o/happy/shiawase-ni.

2. Keep/sonomamanisite/the door/doa-o/open/akete/please/onegaishimasu.

3. The song made/sono-uta-wa, shita/him/kare-o/a star/sutaa-ni.

4. He drives/kare-wa, soju-suru/me/watakusi-o/crazy/kureizii-ni (kare-wa, watakushi-o-furimawasu).

Examples of Modifying Phrases

Adjectival: The books/sono-hon-wa,/on the shelf/sono-hikidashi-no/are all mine/watakushi-no-mono-desu.

Adverbial: Our company has/wagasha-wa, motteimasu/many branches/takusan-no-shiten-o/all over the US/gasshukokuju-ni.

Examples of Relative Pronoun and Relative Adverb

1. The secretary,/sono-hisho-wa,/who was just hired,/sosite-sonohitowa, yatowareta-bakkaridesu/will start/hajime-masu/on Monday/getsuyoubi-ni.

2. My secretary,/watakushi-no-hisho-wa/who has been working/sositesonohito-wa, hataraiteimasu/for me/watakusino-tameni/for one year,/ichinenkann/is very efficient/totemo-yuunoudesu.

3. The city/sono-si-wa,/where/soshite-sokode/I used to live/watakushi-wa-katsute-sundeita/when I was younger,/watakushi-gawakakata-toki/was very beautiful/totemo-kirei-datta.

### Method for Carrying Out Accelerated and Decelerated Listening

In order to perform the accelerated and decelerated listening method, the following embodiment must hold:

1. The English and Japanese language passages are divided into segments whereby the English language passage is arranged in sentences, as is customary. Within each sentence, the phrases are separated by pauses, suspensions, or slashes. The Japanese language passage is arranged to follow the natural order of the English language.

2. Clauses are formed so that each contains a combination of adjoining subject and verb. However, different clauses are formed in the case that a modifier or parenthesis is added between a subject and a verb.

3. “Be” verbs are separated from subjects, but combined into the same segment with complementary adjectives and nouns.

4. In certain languages, some connective words such as “because” and “if” need to be translated at the end of a sentence. However, these words can be translated separately at both the beginning, and the end, of the sentence or phrase. In this case, put the first part of the separated translation right after each connective word so that learners can easily comprehend the meaning.

Given this embodiment, the five step accelerated and decelerated listening method is performed as follows:

1. Hear English sentences spoken at a normal rate: This involves listening to instances of the English language, by reproducing the audio information stored in the first memory 1.1 at a normal rate (100% of the usual language pace) to check the current level of comprehension.

2. Hear combined English and Japanese sentences spoken at a normal rate: This entails listening to instances of the English and Japanese languages, by reproducing the audio information stored in the second memory 1.2 at a normal rate (80-100% of the usual language pace) to confirm the meaning of the sentence. Explanation in Japanese may be produced as required to assist the learner in understanding the practical use of sentence clauses and auxiliary particles.

3. Hear combined English and Japanese sentences spoken at an accelerated rate: Listening to instances of the English and Japanese languages, by reproducing audio information stored in the third memory 1.3 at an accelerated rate (120-220% of the usual language pace) to confirm the meaning of the sentence.

4. Hear English sentences pronounced at a rapid rate: Listening to instances of the English language, by reproducing audio information stored in the fourth memory 1.4 at an accelerated rate (120-220% of the usual language pace).

5. Hear English sentences pronounced for confirmation: This involves listening to instances of the English language, by reproducing audio information stored in the fifth memory 1.5 at a normal rate (100% of the usual language pace) to evaluate the effect of the process and check comprehension. Combining this method with the method of side-by-side translation, forms an effective system to learn and master a foreign language conversation at a rapid rate. The acceleration and deceleration effectively increases the learner's power of concentration and comprehension. The method of side-bye side translation allows the listener to clearly understand the meaning of the sentence, while becoming familiar with the natural word and phrase order used in English sentences. When the conversation is accelerated, the listener is better able to retain the information.

In addition, learning how to correctly shift the phrases of a Japanese sentence to approximate an English one is a very valuable tool. As the sentence still makes sense in Japanese, this alternate structure may be used as a way to generate new sentences. This better enables the learner to use the language in other settings.

### Four Step Speaking Practice

In the embodiment of the present invention, the following four step process is effective to improve speaking abilities:

1 First Listening Process

Listening to Japanese language passages pronounced at a normal rate (100% of the usual language pace).

2 First Speaking Process

Pronouncing the equivalent English language passage, while listening to the Japanese language passage spoken at a normal rate (100% of the usual language pace).

3 Second Speaking Process

Pronouncing the equivalent English language passage, while listening to Japanese language passage pronounced at an accelerated rate (120% of the usual language pace).

4 Second Listening Process

Pronouncing the equivalent English language passage, while listening to the Japanese language passage spoken at a normal rate (100% of the usual language pace).

### Other Embodiments

The invention presented has been designed to promote English language acquisition by learners whose mother tongue is Japanese. It is significant to note that this approach can be modified for use with any number of languages. In particular, it would be an effective tool to help English speakers acquire Japanese.

1. A method for learning a foreign language conversation comprising the steps of:
a) listening to a foreign language sentence pronounced at a normal rate,
b) listening to the same foreign language sentence pronounced at a faster rate, 1.2 to 2.2 times that of the normal rate, on substantially the same pitch of the pronounced sound as that used for usual language pronunciation, and
c) repeating the ordinary and rapid listening of the steps a) and b).

2. The method of claim 1, further comprising at least one of:
a) listening to combined spoken information of the same foreign language sentence and the equivalent mother language sentence pronounced at a normal rate, and
b) listening to this information (a) pronounced at the faster rate.

3. The method of claim 2, with the further addition of:
a) listening to the spoken information of the original foreign language sentence pronounced at a normal rate for confirmatory purposes.

4. The method of claim 2, whereby listening to the spoken combined information of the foreign language sentence at either rate involves:
a) dividing the foreign language sentence into phrases which are separated by pauses, and inserting the equivalent mother language phrase before, between, or after the corresponding foreign language phrase.

5. The method of claim 4, whereby the stressed vowels are elongated and pronounced for 10-30% longer than is normal in any number of the following:
a) listening to the foreign language sentence at the normal rate,
b) listening to the foreign language sentence at the faster rate,
c) listening to the combined language sentence at the normal rate,
d) listening to the combined language sentence at the faster rate, and
e) listening to the confirmatory foreign language sentence.

6. The method of claim 2, wherein the foreign language is the English language and the mother language is the Japanese language.

7. An apparatus for learning a foreign language conversation which is comprised of a storage means; a reproduction means communicated with said storage means; and a speaker means communicated with said reproduction means;
wherein the storage means comprises a first memory for storing first audio information to pronounce a foreign language sentence at a normal rate, and fourth memory for storing fourth audio information to pronounce a foreign language sentence at a faster than the normal rate; and
the fourth memory stores the audio information with adjusted pitch of the pronounced sound, or forwards the audio information from said memory to the reproduction means through a pitch regulator provided in the storage means.

8. The apparatus of claim 7, wherein said storage means further comprises at least one of the second and third memories, said second memory is used to store second audio information to pronounce combined sentences of foreign and mother languages at a normal rate, and said third memory to store third audio information in order to produce combined sentences of foreign and mother languages at a faster than normal rate, further, said third memory stores the third audio information with adjusted pitch of the pronounced sound, or forwards the third audio information from the third memory to said reproduction means through a pitch regulator provided in said storage means.

9. The apparatus of claim 7, wherein said storage means further comprises a fifth memory for storing fifth audio information to produce a confirmatory sentence of the foreign language at a normal rate.

10. The apparatus of claim 8, wherein said second memory and third memory comprise audio information of the mother language wherein the foreign language sentence is pronounced with pauses between phrases, and the equivalent mother phrases are inserted before or after the corresponding phrases of the foreign language sentence.

11. The apparatus of claim 10, wherein one or more of said first, second, third, fourth and fifth memories comprises audio information of the foreign language sentence with stressed vowels pronounced for an extended period of time, 10 to 30% longer than usual in the foreign language.

12. The apparatus of claim 8, wherein the foreign language is the English language and the mother language is the Japanese language.

13. The method of claim 1, wherein the normal listening, rapid listening, and repeating processes are carried out with any of the apparatus specified in claim 8.

14. A method of the Five Fundamental Rules for preparing phrase information, comprising the following First to Fifth Rules:
First Rule:
An English sentence is divided by inserting a pause after a subject, a predicate verb, an object, a complement, a modifier word or phrase, or a connective word or phrase. The sentence is then translated into Japanese by applying a particle or auxiliary word to each of these units, with certain exceptions. No particle or auxiliary word is applied to predicate verbs, certain adverbs, or to connective words or phrases.
Second Rule:
In most cases, a subject and a verb are translated together in a segment so as not to separate those which are consecutive. The Japanese translation is placed after the segment. However, if a modifier word or phrase, or a parenthetical expression, is interposed between a subject and a verb, the subject and verb are translated independently.
Third Rule:
When the verb “be” is used as a predicate verb in the second sentence pattern (that is, a sentence with subject, verb and complement), it is translated with the complement as a segment. The Japanese translation is then added after this segment.
Fourth Rule:
The corresponding Japanese translation is inserted into each pause that follows a subject, a predicate verb, an object, a complement, a modifier word or phrase, or a connective word or phrase.
Fifth Rule:
(1) For a relative pronoun and a relative adverb, the following Japanese translations:
(2) Who: [sosite, sonohito (tachi) wa],
(3) Whose: [sosite, sonohito (tachi) no] or [sosite, sore (ra) no],
(4) Whom: [sosite, sonohito (tachi) o] or [sosite, sonohito (tachi) ni],
(5) That: [sosite, sonohito (tachi) wa] or [sosite, sore (ra) wa],
(6) Which: [sosite, sore (ra) wa],
(7) In which: [sosite, sore (ra) no nakade],
(8) Of which: [sosite, sore (ra) no],
(9) Where: [sosite, sokode],
(10) When: [sosite, sonotoki].
are used, and added after the appropriate phrase of the English sentence.
